(19) United States
(12) Patent Application Publication
(10) Pub. No.: US 2012/0158734 A1
(43) Pub. Date: Jun. 21, 2012

(54) DATA MANAGEMENT SYSTEM AND METHOD

(75) Inventors: Ku Young CHANG, Daejeon (KR); Nam-Su JHO, Daejeon (KR); Taek Young YOUN, Daejeon (KR); Do Won HONG, Daejeon (KR)

(73) Assignee: Electronics and Telecommunications Research Institute, Daejeon (KR)

(21) Appl. No.: 13/328,144

(22) Filed: Dec. 16, 2011

(30) Foreign Application Priority Data
Dec. 17, 2010 (KR) 10-2010-0130186

(51) Int. Cl. G06F 17/30

(52) U.S. Cl. 707/741; 707/758; 707/E17.005; 707/E17.049

(57) ABSTRACT

A data management apparatus includes an index generation unit configured to subdivide an entire interval of data into bucket intervals, allocate indices for the respective bucket intervals, transform the bucket intervals having the allocated indices into bucket intervals of specific lengths, and generate bucket-based indices for pieces of data included in the bucket intervals of the specific lengths. The data management apparatus further includes a data management unit configured to transmit the encrypted data and the bucket-based indices to a server-side data management apparatus in order to store the encrypted data, transmit a user query to the server-side data management apparatus in order to search for a desired encrypted data, and decrypt encrypted data corresponding to the user query from the server-side data management apparatus. The user query includes the index of first bucket interval and the index of second bucket interval neighboring to the first bucket interval.

### CROSS-REFERENCE TO RELATED APPLICATION(S)

The present invention claims priority of Korean Patent Application Nos. 10-2010-0130186, filed on Dec. 17, 2010, which is incorporated herein by reference.

### FIELD OF THE INVENTION

The present invention relates generally to data management technology and, more particularly, to a data management system and method for performing encryption of data based on buckets in a database, and for secure search the encrypted data.

### BACKGROUND OF THE INVENTION

With the rapid development of computer networks, storage capacity, processor technology, etc., the amount of digital information has increased to an unexpected quantity. Further, as need for various types of services has also increased, the necessity to use external servers has at the present time increased.

Actually, there is a report that the amount of universal digital information increases two-fold every 20 months. Therefore, there has been an increase in cases where a user who has a large capacity of data, such as a business, a public institution, and a hospital, stores his or her large-capacity data on external servers so as to reduce costs required for software, hardware and professional manpower which are required to manage his or her database (DB).

However, there have recently been frequent instances where the leakage of client information or the like from external servers due to various types of hacking and insiders occurs. Accordingly, the problems of security and invasions of the privacy related to the information stored in the external servers and have become an important issue.

Information has been protected using access control or key management techniques against external invasions such as hacking, but the seriousness of a security problem that occurs when the manager of an external server that manages data is not reliable is gradually increasing. That is, when the user stores and utilizes his or her important data on the external server, there is no method of preventing the leakage or malicious use of the user's data due to the manager or the like of the external server. Accordingly, the necessity for methods of securely storing the user's data of the user on an unreliable external server and efficiently searching the external server in various manners has increased.

The most basic method for solving this problem is to store encrypted data on an external server after encrypting data. Such a method may be an excellent solution from the standpoint of security, but even the server cannot know about the data, and thus it is impossible to search for data desired by the user. In this case, all pieces of encrypted data that are stored therein are transmitted from the server to the user, and the user decrypts all the pieces of data and then searches for the desired data. However, since this method causes excessive costs for the user, it may in the end be an unrealistic method. Therefore, in order to overcome such a disadvantage, research into technology for attaching additional information, such as indices, to encrypted data and then improving the efficiency of searching is currently being conducted.

Research into searching for encrypted data may be classified into a searchable encryption method, a order-preserving encryption method, a bucket-based index generation method and so on.

For the searchable encryption method, various techniques enabling conjunctive keyword search, subset search, and range search have been proposed. However, due to an excessive computational load, it is almost impossible to apply such technology to actual DBs.

The order-preserving encryption method, which is an encryption technique for preserving the order of pieces of data, enables efficient searching, but the problem of security is presented because the original data can be restored when a plaintext distribution is exposed.

Finally, in the bucket-based index generation method, the entire interval to which data belongs is divided into sub-intervals called buckets, and indices are allocated to respective buckets. Thereafter, when the user queries about a desired bucket index, the server transmits all pieces of data having the relevant index to the user. The user can then find desired data by decrypting the pieces of received data. However, this method is disadvantageous in that although data desired by the user is only part of a bucket, all elements in the bucket must be decrypted, and thus the amount of work to be done by the user increases. Further, as the number of queries for range search increases, information about the locations of buckets may be exposed. For example, it is assumed that the user needs data included in a certain interval and that this interval corresponds to two buckets. In this case, the user transmits indices α and β of the two buckets to the server. However, the indices α and β are always transmitted together in series whenever the same interval is queried about, an attacker may recognize that the indices α and β are those of neighboring buckets. Therefore, there are problems in that as this type of query increases, the attacker can be aware of the location information of buckets, and in that when a plaintext distribution is known, an approximate value of the plaintext included in a bucket may be leaked to the attacker.

### SUMMARY OF THE INVENTION

In view of the above, the present invention provides a data management system and method for enhancing safety storage encrypted data and efficient search of the encrypted data so that an invasion of the privacy is prevented from occurring when the data is stored on an unreliable external server.

Further, the present invention provides a data management system and method for maintaining the security of data even when the plaintext distribution of data is known.

In accordance with a first aspect of the present invention, there is provided to a data management apparatus, including:

an encryption unit configured to encrypting stored data of a user;

an index generation unit configured to subdivide an entire interval of the data into bucket intervals, allocate indices to the respective bucket intervals, transform the bucket intervals having the allocated indices into bucket intervals of specific lengths, and generate bucket-based indices for pieces of data included in the bucket intervals of the specific lengths; and

a data management unit configured to transmit the encrypted data and the bucket-based indices to a server-side data management apparatus in order to store the encrypted data, transmit a user query to the server-side data management apparatus in order to search for a desired encrypted data, and decrypt encrypted data corresponding to the user query which is received from the server-side data management apparatus.

In accordance with a second aspect of the present invention, there is provided to a data management apparatus, including:

an encrypted data database configured to store encrypted data and bucket-based indices for pieces of data included in bucket intervals of specific lengths, which are received from a client-side data management apparatus; and

a data management unit configured to perform a search of encrypted data corresponding to a user query made from the client-side data management apparatus from the encrypted data database and transmit the encrypted data corresponding to the user query to the client-side data management apparatus.

In accordance with a third aspect of the present invention, there is provided to a data management method, including:

encrypting data arranged into a database;

subdividing an entire interval of the data into bucket intervals, and allocating indices for the respective bucket intervals;

transforming the bucket intervals having the allocated indices into bucket intervals of specific lengths to generate bucket-based indices for pieces of data included in the bucket intervals of the specific lengths; and

transmitting the encrypted data and the bucket-based indices to a server-side data management apparatus for the storage thereof.

In accordance with a fourth aspect of the present invention, there is provided to a data management method, including:

storing encrypted data and bucket-based indices which are received from a client-side data management apparatus;

when a user query is received from the client-side data management apparatus, searching for encrypted data corresponding to the user query; and

transmitting the encrypted data corresponding to the user query to the client-side data management apparatus.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram a data management system in accordance with an embodiment of the present invention;

FIG. 2 is a flowchart illustrating a data management method performed by a client terminal shown in FIG. 1 in accordance with an embodiment of the present invention;

FIG. 3 is a flowchart illustrating a data management method performed by a server shown in FIG. 1 in accordance with an embodiment of the present invention;

FIG. 4 is a diagram illustrating the process for index generation of FIG. 2; and

FIG. 5 is a diagram illustrating the process for query transmission of FIG. 2.

### DETAILED DESCRIPTION OF THE PREFERRED EMBODIMENTS

The present invention is intended to provide a method of securely storing data and improving the efficiency of searching, which can prevent an invasion of the privacy that may occur when the important large-capacity data of a user is stored on an unreliable external server. Further, the present invention is intended to provide an encrypted data search method, which can maintain security even when the plaintext distribution of data is known.

In particular, it can be assumed that the plaintext distribution of most of the pieces of actual data is open to the public. For example, it can be considered that test scores may have values ranging from 0 to 100, and the distribution thereof conforms to a normal distribution. As shown in this example, the assumption that the distribution of the plaintext data is known is reasonable, and the security of a data set, the plaintext distribution of which is exposed, must be taken into consideration at the time of designing an encrypted data search method.

For this, the present invention is configured to divide the entire interval to which data belongs into sub-intervals called buckets, and sets indices capable of representing respective buckets. Thereafter, in order to randomly transform a plaintext distribution of elements belonging to each bucket, a private value m greater than the size of the bucket is selected, mod m multiplication is performed, and final results are linearly transformed into a desired interval of the long length. Further, when the user queries the server about the index of his or her desired bucket, the index of a neighboring bucket in addition to the index of the queried bucket is additionally queried about, thus making it difficult for the server to derive the location information of the buckets.

By using this method, even when a plaintext distribution is exposed, a secure encrypted data search method can be provided. Further, before the encrypted data is decrypted, information about desired data is searched for using elements included in each bucket that has been transformed using modulo multiplication and linear transformation, so that only required data is decrypted, thus efficient searching can be performed compared to the existing method.

Hereinafter, embodiments of the present invention will be described in detail with reference to the attached drawings.

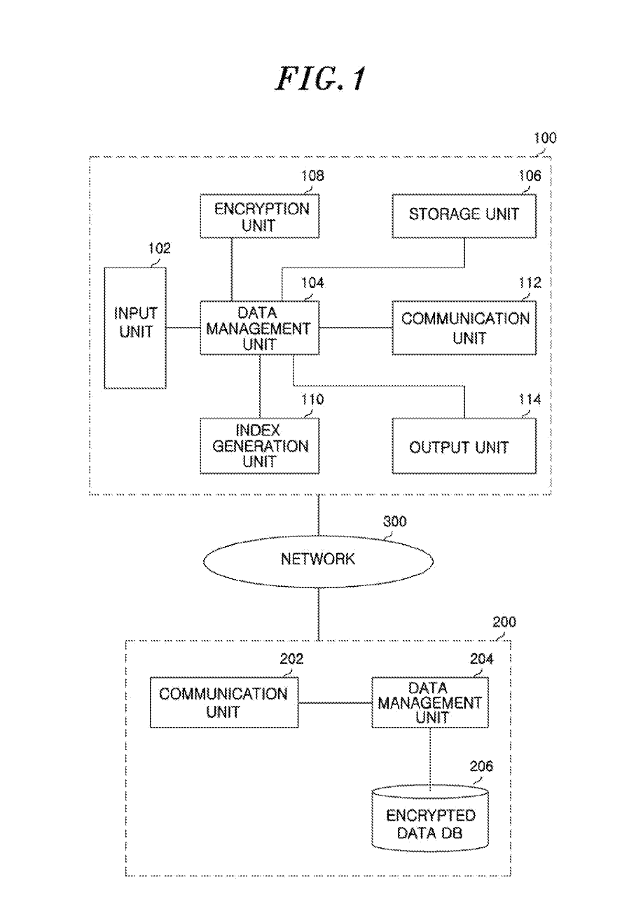

FIG. 1 is a block diagram showing a data management system in accordance with an embodiment of the present invention. In detail, the data management system includes a client-side data management apparatus 100 and a server-side data management apparatus 200. These apparatuses 100 and 200 may be mutually connected to each other via a network 300.

The client-side data management apparatus 100 encrypts significant data of a user and transmits the encrypted data to the server-side data management apparatus 200 for the safety storage thereof. Further, the client-side data management apparatus 100 provides a query to the server-side data management apparatus 200 to search for encrypted data corresponding to the query.

Meanwhile, the server-side data management apparatus 200 retrieves the encrypted data corresponding to the query to transmit the retrieved encrypted data to client-side data management apparatus 100.

First, the client-side data management apparatus 100 includes an input unit 102, a data management unit 104, a storage unit 106, an encryption unit 108, an index generation unit 110, a communication unit 112, and an output unit 114.

The input unit 102 serves to input a query of a user. The query input through the input unit 102 is then provided to the data management unit 104.

The data management unit 104 manages the encryption unit 108 and the index generation unit 110. In detail, the data management unit 104 performs management so that data is retrieved from the storage unit 106 and is then encrypted using the encryption unit 108 and so that bucket-based indices are generated using the index generation unit 110.

Further, the data management unit 104 controls the communication unit 112 so that when the query is input from the input unit 102, the query is transmitted to the server-side data management apparatus 200 over the network 300. In this case, when a query for the index of any first bucket interval is input, the data management unit 104 generates a cyclic bucket query in which the index of a neighboring second bucket interval is added to the index of the first bucket interval. The cyclic bucket query is then transmitted as a user query to the server-side data management apparatus 200.

The data management unit 104 also directs the encryption unit 108 and the index generation unit 114 to decrypt encrypted data corresponding to the user query which is received from the server-side data management apparatus 200. The decrypted data from the encrypted data corresponding to the user query is then output through the output unit 114.

The received encrypted data includes encrypted data corresponding to both the index of the first bucket interval and the index of the second bucket interval. However, in the embodiment of the present invention, upon decryption, the encrypted data corresponding to only the index of the first bucket interval may be decrypted.

As set forth above, although the amount of data to be transmitted owing to the addition of the second bucket interval is slightly increased, an attacker does not know which bucket is a start bucket if a cyclic bucket query is used, and thus security against the leakage of the location information of buckets can be enhanced.

The storage unit 106, which may include a database (DB), stores pieces of significant data of a client. The encryption unit 108 functions to encrypt the data arranged in the storage unit 106.

The index generation unit 110 subdivides the entire interval of the data into bucket intervals, allocates indices for the respective bucket intervals, and transforms the bucket intervals having the indices into bucket intervals of specific lengths, to thereby generate bucket-based indices for pieces of data in the bucket intervals of the specific lengths.

The communication unit 112 functions to transmit the encrypted data from the encryption unit 108, the bucket-based indices from the index generation unit 110, and the user query from the input unit 102 to the server-side data management apparatus 200 over the network 300. Further, the communication unit 112 receives the encrypted data from the server-side data management apparatus 200.

The output unit 114 functions to output any data which has been decrypted from the encrypted data, in compliance with a command from the data management unit 104. Meanwhile, the server-side data management apparatus 200 includes a communication unit 202, a data management unit 204, and an encrypted data DB 206.

The communication unit 202 receives the encrypted data and the bucket-based indices, which are provided for the safety storage of the encrypted data by the client-side data management apparatus 100, and provides them to the data management unit 204. Further, the communication unit 202 receives the user query, which is provided for the retrieval of encrypted data by the client-side data management apparatus 100, and provides it to the data management unit 204. The encrypted data retrieved by the data management unit 204 is transmitted to the client-side data management apparatus 100.

The data management unit 204 performs data management so that the encrypted data and the bucket-based indices, which are provided from the client-side data management apparatus 100 via the communication unit 202, are stored in the encrypted data DB 206. Further, the data management unit 204 controls the communication unit 202 so that when the user query from the client-side data management apparatus 100 are received via the communication unit 202, encrypted data corresponding to the user query is retrieved from the encrypted data DB 206 and the retrieved encrypted data is transmitted to the client-side data management apparatus 100. In this case, the user query includes the index of first bucket interval and the index of second bucket interval added to the first bucket interval.

The encrypted data DB 206 is managed by the data management unit 204 to store the encrypted data and the bucket-based indices received from the client-side data management apparatus 100.

The network 300 includes a wide area network (WAN) and a local area network (LAN), and connects between the client-side data management apparatus 100 and the server-side data management apparatus 200, thus enabling the data management service in accordance with an embodiment of the present invention, for example, data encryption, index generation, the transmission of encrypted data and user query, the storage and searching of encrypted data, and the output of the encrypted data.

In this case, the WAN may be, for example, the Internet, which denotes a universal open-type computer network architecture for providing various types of services present in Transmission Control Protocol (TCP)/Internet Protocol (IP) and upper layers thereof, that is, Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), and Network Information Service (NIS). The WAN may provide a wired communication environment in which the encrypted data, index information, user query information, etc. generated by the client-side data management apparatus 100 can be transferred to the server-side data management apparatus 200 or in which the encrypted data retrieved from the server-side data management apparatus 200 can be transferred to the client-side data management apparatus 100.

The LAN provides a local area communication environment between the client-side data management apparatus 100 and the server-side data management apparatus 200, and includes, for example, a LAN, Wi-Fi (Wireless Fidelity) network, etc.

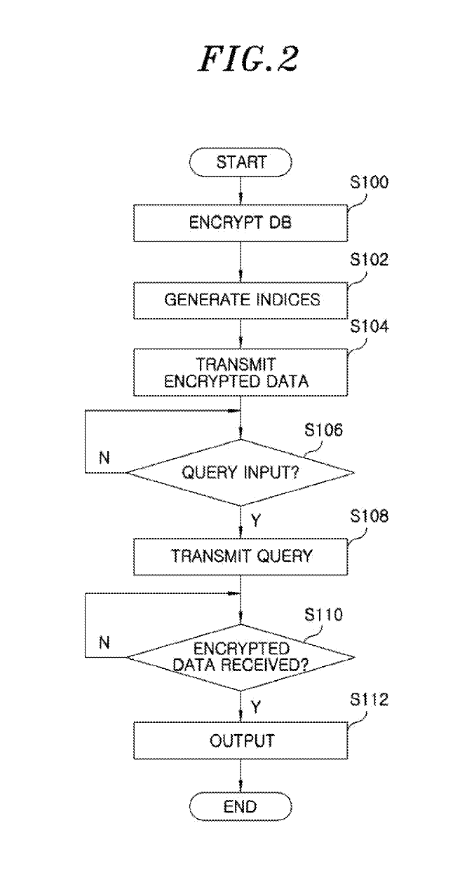

Hereinafter, a data management method in accordance with the present invention will be described in detail with reference to FIGS. 2 to 5.

The data management method, which is proposed in the embodiment of the present invention, includes the following procedures: a DB encryption procedure, an index generation procedure, a storage procedure and a query procedure, which are performed by the client-side data management apparatus 100; and a search procedure, a transmission procedure and a data output procedure, performed by the server-side data management apparatus 100.

In the DB encryption procedure, data stored in a DB 106 is encrypted.

In the index generation procedure, an interval to which the data belongs is divided into sub-intervals called buckets, indices are allocated for the respective buckets, modulo m multiplication is applied to the data, belonging to each of the buckets, using m greater than the size of the bucket, and buckets obtained by multiplication are linearly transformed into a long bucket interval of the desired length, and thus indexes for pieces of data allocated in the bucket are generated.

In the storage procedure, the encrypted DB obtained in the DB encryption procedure and the index generation procedure is stored on the server-side data management apparatus 200.

In the query procedure, in order to search encrypted data from the encrypted data DB 204, the client-side data management apparatus 100 makes a user query including a cyclic bucket query.

In the search procedure, the server-side data management apparatus 200 searches for encrypted data based on a query received from the client-side data management apparatus 100.

In the transmission procedure, the results of search are transmitted to the client-side data management apparatus 100.

In the data output procedure, the client-side data management apparatus 100 decrypts and outputs the encrypted data received from the server-side data management apparatus 200.

FIG. 2 illustrates a data management method performed by the client-side data management apparatus 100. As shown in FIG. 2, the data management method performed by the client-side data management apparatus 100 includes steps S100 to S112.

At step S100, pieces of data arranged into a DB are encrypted to produce the pieces of encrypted data.

At step S102, the entire interval of the data is subdivided into bucket intervals, indices are allocated for respective bucket intervals derived from the subdivision, and the bucket intervals with the allocated the indices are transformed into bucket intervals of specific lengths to generate bucket-based indices for the pieces of data included in the bucket intervals of the specific lengths.

At step S104, the pieces of encrypted data and the bucket-based indices are transmitted to the server-side data management apparatus 200.

Thereafter, at step S106, when a query for the index of any first bucket interval is input in order to search encrypted data from the encrypted data DB 204, the index of a neighboring second bucket interval is added to the index of the first bucket interval, to thereby produce the user query.

At step S108, the user query in which the index of a neighboring second bucket interval is added to the index of the first bucket interval is transmitted to the server-side data management apparatus 200.

At step S110, pieces of encrypted data corresponding to the user query are received from the server-side data management apparatus 200.

At step S112, among the pieces of received encrypted data, only encrypted data corresponding to the user query for the index of the first bucket interval is decrypted.

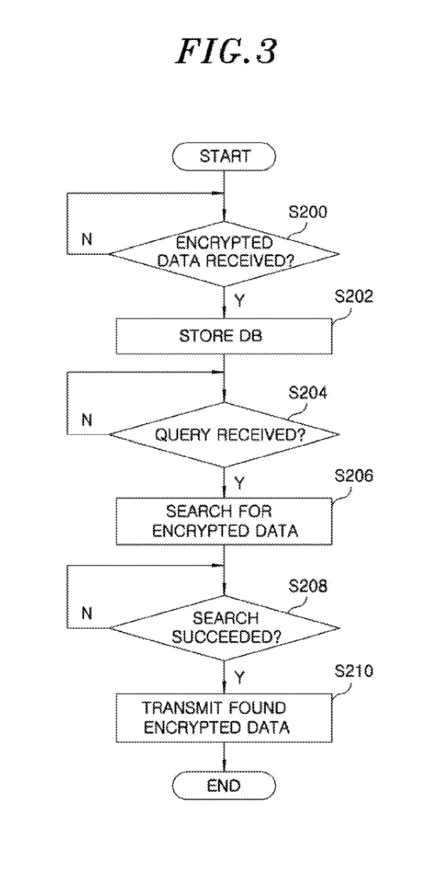

FIG. 3 illustrates a data management method performed by the server-side data management apparatus 200.

As shown in FIG. 3, the data management method performed by the server-side data management apparatus 200 includes steps S200 to S210.

At step S200, it is determined whether encrypted data and bucket-based indices have been received from the client-side data management apparatus 100.

At step S202, the encrypted data and bucket-based indices are stored in the encrypted data DB 204.

Thereafter, at step S204, it is determined whether a user query, in which the index of a neighboring second bucket interval is added to the index of the first bucket interval, has been received from the client-side data management apparatus 100.

At step S206, if it is determined that the user query has been received from the client-side data management apparatus 100, encrypted data corresponding to the received user query is searched from the encrypted data DB 204.

At step S208, it is determined whether the search has succeeded.

At step S210, the encrypted data that was successfully searched is transmitted to the client-side data management apparatus 100.

In the embodiment of the present invention, Table 1 and Table 2 are used for the sake of convenient description. Table 1 indicates an example of user IDs and their salaries arranged in a DB. Table 2 indicates an example of encrypted data obtained by encrypting the DB of Table 1 using the method described in the present invention.

TABLE 1

| id_number | salary |
|---|---|
| 68 | 480 |
| 7 | 340 |
| 11 | 790 |
| 31 | 630 |
| 29 | 435 |
| 57 | 724 |
| 51 | 587 |
| 14 | 412 |
| 21 | 345 |
| 39 | 480 |
| 55 | 607 |
| 17 | 530 |

TABLE 2

| | E-id_number | | E-salary | |
|---|---|---|---|---|
| E-tuple | B-index | Ind-id_number | B-index | Ind-salary |
| 1100110011100 . . . | τ | 4501 | β | 4221 |
| 1000011100010 . . . | π | 4401 | α | 6541 |
| 1010011001111 . . . | π | 3015 | δ | 7069 |
| 1111010000111 . . . | σ | 3851 | δ | 9831 |
| 1001011001110 . . . | ρ | 7951 | β | 8537 |
| 1110111100010 . . . | τ | 7900 | δ | 4207 |
| 1000000001100 . . . | σ | 647 | γ | 7631 |
| 1101011000010 . . . | π | 4599 | α | 6299 |
| 1011011011010 . . . | ρ | 2001 | α | 4851 |
| 0101011010010 . . . | σ | 4560 | β | 4211 |
| 1101011010011 . . . | τ | 3966 | γ | 2157 |
| 1001011010101 . . . | ρ | 3999 | γ | 6780 |

At the data encryption step S100, the user may randomly generate a private key K for encryption and may encrypt pieces of data stored in the DB using a symmetric key encryption algorithm.

A first column in an E-tuple of Table 2 means that 1100110011100 . . . =Eₓ(68,480), where Eₓ( ) denotes a symmetric key encryption algorithm having a private key K, and the E-tuple may denote a value obtained by encrypting the value in each row of Table 1.

The index allocation step S102 includes generating bucket indices and allocating indices for pieces of data included in each bucket.

First, in order to generate the bucket indices, the entire interval of pieces of data in the DB 106, for example, B=[a,b], is divided into sub-intervals called buckets, B₁=[a₀(=a),a₁),B₂=[a₁,a₂), . . . , Bₖ=[aₖ₋₁,aₖ(=b)]. During the interval is divided, it is preferred that an identical number of pieces of data are included in individual buckets. Alternatively, the interval may be divided such that an almost identical or similar number of pieces of data are included in the buckets. Next, random indices are generated for respective buckets and are then allocated to the buckets, respectively, and the start point, the end point, and the index of each bucket may be stored for searching.

The salary of Table 1 may be considered as follows. If the entire range of salaries is B=[300,800], it can be divided into four sections such as B₁=[300,420), B₂=[420,500), B₃=[500,620), and B₄=[620,800]. Indices α, β, γ and δ are allocated to the respective buckets B₁, B₂, B₃ and B₄. As shown in Table 2, the allocated indices α, β, γ and δ are stored in B-index of the individual pieces of attribute information E-id_number and E-salary. Thereafter, the user stores (300, 420, α), (420, 500, β), (500, 620, γ), and (620, 800, δ) in which the buckets include the indices for later searching. Such indices can be easily generated using various methods that utilize a hash function including a private key only the user knows, a random number generator, etc.

In the index allocation step S102, the step of generating indices for pieces of data in each bucket enables efficient searching while preserving security even when a distribution of plaintext data is known, which will be described below.

First, the client-side data management apparatus 100 selects, for a bucket Bᵢ=[aᵢ₋₁,aᵢ), a prime mᵢ greater than the length aᵢ-aᵢ₋₁ of that bucket, and selects qᵢ satisfying 0<qᵢ<mᵢ.

Accordingly, the client-side data management apparatus 100 can calculate, for data t included in the bucket Bᵢ, a modulo multiplication formula given as follows.

(t−aᵢ₋₁)·qᵢ mod mᵢ [Equation 1]

Using this modulo multiplication, the data can be randomly transformed so that an attacker cannot be aware of the distribution of plaintext data. For each bucket, only mᵢ and qᵢ can be stored as private values that only the user knows.

By performing the above procedure, the data belonging to Bᵢ=[aᵢ₋₁,aᵢ) can be transformed into data included in the bucket B*ᵢ=[0,mᵢ).

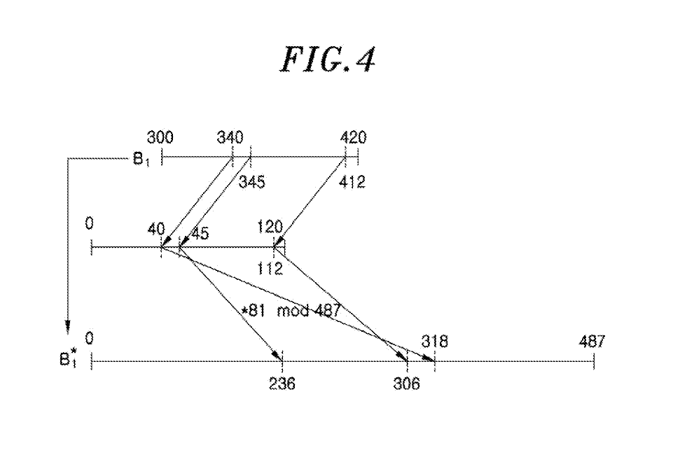

For example, in the case of salary of Table 1, B₂=[420,500) includes three pieces of data 340, 345 and 412. In this case, the length of B₁ is 420−300=120, and m₁=487 and q₁=81 are set. Then, as shown in FIG. 4, 340 is transformed into 318 by (340−300)·81 mod 487≡=40˜81 mod 487≡318 mod 486, 345 is transformed into 236, and 112 is transformed into 306. That is, the pieces of data 340, 345, and 412 included in B₁=[300,420) is transformed into 318, 236, and 306 included in B*₁=[0,487).

When m₂=373 and q₂=71 are set for B₂=[420,500), three pieces of data 435, 480 and 480 are transformed into pieces of data 319, 157 and 157 included in B₂=[0,373). Similarly, data may be transformed by setting m₃=523 and q₃=221 for B₃=[500,620) and by setting m₄=811 and q₄=323 for B₄=[620,800).

Second, data included in B*ᵢ=[0,mᵢ) transformed from B*ᵢ=[aᵢ₋₁,aᵢ) is transformed into data included in a single specific interval of a long length. This specific interval is called a target bucket TB=[c,d], and the length of TB is designated to satisfy the following Equation 2 so that private values mᵢ cannot be known.

|TB|=d−c>>max_{1≦i≦k}{mᵢ} [Equation 2]

where >> denotes extremely large magnitude.

Now, a method of transforming data included in B*ᵢ=[0,mᵢ) into data included in TB=[c,d] will be proposed. For xεBᵢ=[0,mᵢ), a function F given by the following Equation 3 can be considered.

$${F}_{{B}_{i}^{*}} ( x ) = c + \frac{x}{{m}_{i}} \times ( d - c ) \qquad [ Equation 3 ]$$

It can be seen that the function F is a linear transformation for transforming data included in B*ᵢ=[0,mᵢ) into data included in TB=[c,d].

It is assumed that a value obtained by transforming yεBᵢ using modulo multiplication is y̅εB*ᵢ=[0,mᵢ). The user calculates └F_{B*}_{₁}( y̅)┘ and └F_{B*}_{₁}( y̅+1)], where └t┘ denotes the largest integer smaller than t. For example, └3.3┘=3.

Thereafter, y* satisfying the following Equation 4 can be randomly selected.

└F_{B*}_{₁}( y̅)┘≦y*≦└F_{B*}_{₁}( y̅+1)┘ Equation (4)

Using this method, y̅εB*ᵢ can be transformed into y*εTB. That is, yεBᵢ is transformed into y*εTB, and this value y* is defined as the index of y. This transformation is performed to transform pieces of data having the same value into different values in TB when a plurality of pieces of data have the same value. This operation may function to prevent the leakage of plaintext information that occurs when a plurality of pieces of plaintext data are transformed into the same information.

Bᵢ=[420, 500) of Table 1 will be described by way of example. In the above example, three pieces of data 435, 480, and 480 belonging to B₂ are transformed into three pieces of data 319, 157 and 157 belonging to B*ᵢ=[0, 373) by modulo multiplication. Then, when TB=[0,10000], a function F given by the following Equation 5 can be considered.

$${F}_{{B}_{2}^{*}} ( x ) = \frac{x}{373} \times ( 10000 ) \qquad [ Equation 5 ]$$

For 319, └F_{B*}_{₂}(319)┘=8522 and └F_{B*}_{₂}(320)┘=8579 are satisfied. Then, 319 can be transformed into a random value 8537 between 8522 and 8579. That is, it can be seen that data 435 included in B₂=[420, 500) is transformed into an element 8537 included in TB, and the index of 435 is stored as 8537 in the ind-salary of Table 2.

Now, the transformation of two pieces of identical data 157 belonging to B*₂ will be considered.

For 157, └F_{B*}_{₂}(157)┘=4209 and └F_{B*}_{₂}*(158)┘=4235 are satisfied. The user can select random values 4211 and 4221 between 4209 and 4235. Then, it can be seen that two pieces of identical data 480 belonging to B*₂ can be transformed into 4211 and 4221 included in TB via B*₂. Therefore, the indices of the two pieces of data 480 may be stored as 4211 and 4221 in the ind-salary of Table 2.

The storage step S202 is to store the encrypted DB, obtained by performing steps S100 and S102, in the server-side data management apparatus 200. The storage step S202 denotes a procedure to store Table 2 on the server-side data management apparatus 200 when plaintext data is given as shown in Table 1.

The user query step S106 includes transmitting the index information, stored on the client-side data management apparatus 100, to the server-side data management apparatus 200 so as to make a query about desired data. In this case, in an embodiment of the present invention, a cyclic bucket query is made for security. The cyclic bucket query is to simultaneously query about both a first bucket actually desired to be queried by the client-side data management apparatus 100 and a second bucket neighboring to the desired first bucket.

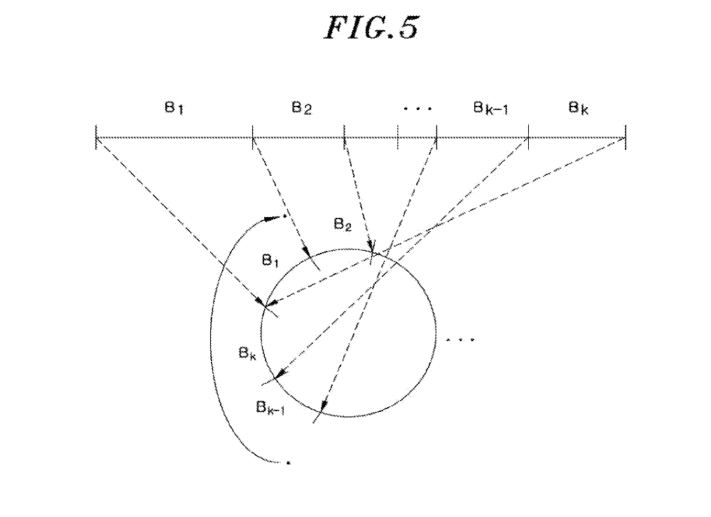

As shown in FIG. 5, when the client-side data management apparatus 100 intends to query about buckets Bₖ₋₁ and Bₖ, the client-side data management apparatus 100 queries the server-side data management apparatus 200 about Bₖ₋₁, Bₖ and B₁. Of course, the server-side data management apparatus 200 transmits encrypted data belonging to Bₖ₋₁, Bₖ and B₁ to the client-side data management apparatus 100, but the client-side data management apparatus 100 decrypts only buckets Bₖ₋₁ and Bₖ desired to be queried about. That is, the amount of data transmitted from the server-side data management apparatus 200 to the client-side data management apparatus 100 slightly increases, but there is no great different in computational load on the user.

Similarly to the existing bucket method, when a large number of range queries are made, information about the locations of the buckets may be exposed. In particular, when the distribution of plaintext is known, information about pieces of data belonging to each bucket may be leaked.

However, when the cyclic bucket query proposed in the present invention is used, an attacker does not know which bucket is a start bucket, thus providing security against the leakage of the location information of buckets.

Taking Table 1 as an example, it is assumed that the user desires the data of a salary included in [600, 700]. It is satisfied that [600,700]=[600,620)∪[620, 700), and it can be seen from the bucket information of the user that [600, 620) [symbol] [500, 620) and [620, 700) [symbol] [620, 800]. In this case, as shown in Table 2, the user transmits indices and data type information, corresponding to buckets [500, 620) and [620, 800), and the index (E−salary; γ,δ,α) of the subsequent bucket [300, 420] to the server-side data management apparatus 200.

When a large number of queries are made using this method, the existing method may be exactly aware of the fact that bucket indices have been allocated in the sequence of α, β, γ, and δ from the first bucket. In contrast, when the cyclic bucket query proposed in the embodiment of the present invention is made, it can be aware of only the fact that the indices of the buckets are β, γ, δ and α, but it cannot be aware of an index to which an initially starting bucket has been allocated, thus strengthening security for the location information of the buckets.

The search step S206 includes searching the encrypted DB on the basis of the query received from the client-side data management apparatus 100, and then transmitting the results of search to the user.

It is assumed that at the user query information reception step S204 that the server-side data management apparatus 200 has received (E−salary; γ,δ,α) from the client-side data management apparatus 100. The server-side data management apparatus 200 then transmits data in 2nd, 3rd, 4th, 6th, 7th, 8th, 9th, 11th and 12th rows, in which the B-index values of E-salary are γ,δ and α in Table 2, to the user.

The data output step S112 includes outputting required data among the pieces of encrypted data transmitted from the server-side data management apparatus 200.

First, the client-side data management apparatus 100 excludes data that has been additionally transmitted due to the cyclic bucket query, and invokes a privately stored value mᵢ. Next, by using a function represented by the following Equation 6 and configured to transform B*ᵢ=[0,mᵢ) into TB=[c,d], an inverse transform represented by the following Equation 7 can be obtained.

$$\begin{matrix}{F}_{{B}_{i}^{*}} ( x ) = C + \frac{x}{{m}_{i}} \times ( d - c ) & [ Equation 6 ] \\ {F}_{{B}_{i}^{*}}^{- 1} ( x ) = \frac{x - c}{d - c} \times ( {m}_{i} ) & [ Equation 7 ]\end{matrix}$$

By using this inverse transform function, data present in TB=[c,d] can be transformed into data in B*ᵢ=[0,mᵢ). That is, when xεTB, └F_{B*}_{₂}⁻¹(x)┘εB*ᵢ is satisfied.

Thereafter, the client-side data management apparatus 100 calculates └F_{B*}_{₂}⁻¹(x)┘·qᵢ⁻¹ mod mᵢ+aᵢ₋₁ using the privately stored value qᵢ and (t−aᵢ₋₁)·qᵢ mod mᵢ given in Equation 1 of the modulo multiplication, and is then capable of restoring plaintext data included in Bᵢ=[aᵢ₋₁,aᵢ). Here, since the calculation of qᵢ⁻¹ is the operation of an inverse element that consumes time, the client-side data management apparatus 100 can readily perform the above restoration by using only multiplication if qᵢ⁻¹ is calculated in advance and is stored as a private value. Using this procedure, the client-side data management apparatus 100 can perform decryption only on required encrypted text from the restored plaintext data.

As described above, since plaintext can be restored from indices by performing a simple calculation, decryption can be efficiently performed compared to the time during which the entire encrypted data E-tuples received from the server-side data management apparatus 200 is decrypted.

In examples of the user query steps S106 and S108 and the search steps S206, S208, and S210, the client-side data management apparatus 100 receives data in 2nd, 3rd, 4th, 6th, 7th, 8th, 9th, 11th, and 12th rows from the server-side data management apparatus 200. Among the pieces of data, pieces of data in which the B-index value of E-salary is α has been additionally received as the cyclic bucket query, and thus the client-side data management apparatus 100 needs to investigate only data in 3rd, 4th, 6th, 7th, 11th and 12th rows. Therefore, the client-side data management apparatus 100 decrypts only data in which salary belongs to [600, 700] in E-tuple by using Ind-salary present in the 3rd, 4th, 6th, 7th, 11th and 12th rows, to yield required data. For example, a value of Ind-salary in the 7th row is 7631, and a B-index is γ. The client-side data management apparatus 100 can be aware of the fact that data 7631 has been transformed from the buckets B₃=[500, 620) and B*₃=[0,523), on the basis of the index γ, and that q₃=221. First, by an inverse transform from TB=[0,10000] into B*₃=[0,523), the following Equation 8 can be obtained.

$$⌊ {F}_{{B}_{i}^{*}}^{- 1} ( 7631 ) ⌋ = ⌊ \frac{7631}{10000} \times ( 523 ) ⌋ = 399 \qquad [ Equation 8 ]$$

Therefore, the plaintext data 399·221⁻¹ mod 523+500=587 can be restored. Since this data does not belong to [600, 700], there is no need to decrypt a relevant E-tuple. By way of this procedure, it can be seen that salary value in 4th and 11th rows belong to [600, 700], and the client-side data management apparatus 100 can obtain the desired data by decrypting only E-tuples present in 4th and 11th rows in Table 2.

This procedure can also be applied to attribute E-id_number in the similar manner. In the case of the actual application, this procedure may be applied to a DB having a much larger number of attributes. Further, it is possible to search for two or more attributes.

In accordance with the above-described embodiments of the present invention, there is implemented an encrypted data management technology, which can securely store data and improve the efficiency of searching by preventing an invasion of the privacy that may occur when the important large-capacity data of a user is stored on an unreliable external server, and which can maintain security even when the plaintext distribution of data is known.

As described above, in accordance with the present invention, there are advantages in that an invasion of the privacy that may occur when the data of a user is stored on an unreliable external server can be prevented, thus securely storing data and improving search efficiency. Further, the present invention can maintain security even when the plaintext distribution of data is known.

In detail, the present invention can provide an encryption method for securely storing DBs, an index generation method for concealing the distribution of plaintext, a user query technique for secure searching, and an efficient encrypted data search method, when the important DB of a user is stored on an external server. Further, unlike existing methods in which problems may occur in security when the distribution of plaintext data is known, the present invention can further strengthen security even when the distribution of plaintext data is known, by means of a data-based index generation method, enabling the plaintext distribution to be randomly transformed, and a cyclic bucket query. Furthermore, since the present invention decrypts only required encrypted data by restoring plaintext data using a simple operation on the indices of data instead of decrypting all pieces of encrypted data corresponding to a relevant bucket, efficiency can be improved from the standpoint of a user. Further, the present invention does not require a new DB system for the encryption of DBs and searching for encrypted data, and the system of the present invention may be implemented using the existing DB system.

Thanks to these advantages, the present invention can provide a substantial security technology that prevents an invasion of the privacy of DBs, the importance of which has gradually become emphasized, and a system technology that can be easily implemented.

While the invention has been shown and described with respect to the preferred embodiments, it will be understood by those skilled in the art that various changes and modifications may be made without departing from the spirit and scope of the invention as defined in the following claims.

What is claimed is:

1. A data management apparatus, comprising:
an encryption unit configured to encrypting stored data of a user;
an index generation unit configured to subdivide an entire interval of the data into bucket intervals, allocate indices to the respective bucket intervals, transform the bucket intervals having the allocated indices into bucket intervals of specific lengths, and generate bucket-based indices for pieces of data included in the bucket intervals of the specific lengths; and
a data management unit configured to transmit the encrypted data and the bucket-based indices to a server-side data management apparatus in order to store the encrypted data, transmit a user query to the server-side data management apparatus in order to search for a desired encrypted data, and decrypt encrypted data corresponding to the user query which is received from the server-side data management apparatus.

2. The data management apparatus of claim 1, wherein the user query includes a cyclic bucket query in which the index of a neighboring second bucket interval is added to the index of the first bucket interval.

3. The data management apparatus of claim 2, wherein the encrypted data received from the server-side data management apparatus comprises encrypted data corresponding to the index of the first bucket interval and encrypted data corresponding to the index of the second bucket interval.

4. The data management apparatus of claim 3, wherein the data management unit is configured to decrypt the encrypted data corresponding to the index of the first bucket interval when decrypting the encrypted data received from the server-side data management apparatus.

5. The data management apparatus of claim 1, wherein the data management unit further comprises a communication unit configured to transmit the encrypted data from the encryption unit and the bucket-based indices from the index generation unit and the user query to the server-side data management apparatus over a network, and configured to receive the encrypted data corresponding to the user query from the server-side data management apparatus.

6. The data management apparatus of claim 1, wherein the data management unit further comprises an output unit configured to output decrypted data on which the encrypted data received from the server-side data management apparatus has been decrypted under a control of the data management unit.

7. The data management apparatus of claim 1, wherein the pieces of data included in the bucket intervals is subject to a modulo multiplication.

8. A data management apparatus, comprising:
an encrypted data database configured to store encrypted data and bucket-based indices for pieces of data included in bucket intervals of specific lengths, which are received from a client-side data management apparatus; and
a data management unit configured to perform a search of encrypted data corresponding to a user query made from the client-side data management apparatus from the encrypted data database and transmit the encrypted data corresponding to the user query to the client-side data management apparatus.

9. The data management apparatus of claim 8, wherein the user query includes a cyclic bucket query in which the index of a neighboring second bucket interval is added to the index of the first bucket interval.

10. The data management apparatus of claim 8, wherein the bucket-based indices are generated by subdividing an entire interval of data in the client-side data management apparatus into bucket intervals, allocating indices for the respective bucket intervals, and transforming the bucket intervals having the allocated indices into bucket intervals of specific lengths.

11. The data management apparatus of claim 8, wherein the communication unit is configured to receives the encrypted data and the bucket-based indices and the user query, which are provided by the client-side data management apparatus, and transmit the encrypted data corresponding to the user query to the client-side data management apparatus over the network.

12. A data management method, comprising:
encrypting data arranged into a database;
subdividing an entire interval of the data into bucket intervals, and allocating indices for the respective bucket intervals;
transforming the bucket intervals having the allocated indices into bucket intervals of specific lengths to generate bucket-based indices for pieces of data included in the bucket intervals of the specific lengths; and
transmitting the encrypted data and the bucket-based indices to a server-side data management apparatus for the storage thereof.

13. The data management method of claim 12, wherein said generating the bucket-based indices comprises performing modulo multiplication on the pieces of data included in the bucket intervals.

14. The data management method of claim 12, wherein said transforming the bucket intervals having the allocated indices comprises performing linear transformation.

15. The data management method of claim 12, further comprising:
when a query for an index of a first bucket interval is input, adding an index of a neighboring second bucket interval to the first bucket interval, to thereby produce the user query;
transmitting the user query to the server-side data management apparatus;
receiving the encrypted data corresponding to the user query from the server-side data management apparatus; and
decrypting the encrypted data corresponding to only the first bucket interval, among the encrypted data.

16. A data management method, comprising:
storing encrypted data and bucket-based indices which are received from a client-side data management apparatus;
when a user query is received from the client-side data management apparatus, searching for encrypted data corresponding to the user query; and
transmitting the encrypted data corresponding to the user query to the client-side data management apparatus.

17. The data management method of claim 16, wherein the bucket-based indices are generated by subdividing an entire interval of data in the client-side data management apparatus into bucket intervals, allocating indices for the respective bucket intervals, and transforming the bucket intervals having the allocated indices into bucket intervals of specific lengths.

18. The data management method of claim 16, wherein the user query comprises a cyclic bucket query in which an index of a neighboring second bucket interval is added to the index of the first bucket interval.
